(19) United States
(12) Patent Application Publication
(10) Pub. No.: US 2006/0068178 A1
(43) Pub. Date: Mar. 30, 2006

(54) Fusible printing media

(76) Inventors: Molly Hladik, San Diego, CA (US); David Rossing, San Diego, CA (US); Radha Sen, San Diego, CA (US); Steven L. Webb, Murrieta, CA (US); Richard J. McManus, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/951,431

(22) Filed: Sep. 28, 2004

(51) Int. Cl. B41M 5/00

(52) U.S. Cl. 428/207

(57) ABSTRACT

A method and coating for printing a substantially permanent and smudge, water, and air fade resistant image on recording media is herein disclosed. The method involves the steps of formulating the coating, applying the coating to the recording media, drying the coating, forming an image on the coated recording media, drying the image on the recording media to remove the solvents from the colorants used to form the image, and fusing the coating to protective film over the recording media that substantially encapsulates the colorants used to print the image, thereby rendering the image substantially smudge, water, and air fade resistant. The coating includes a quantity of fusible particles admixed with a binder. In one formulation, the coating also includes a mordant. The coating itself is capable of absorbing and retaining colorants applied thereto and may therefore be used on absorbent or non-absorbent recording media.

### BACKGROUND

The present invention relates to a fusible coating for media. More specifically, the present invention relates to a coating for media that includes fusible particles that, after fusion, encapsulate the colorants used to print an image on the media, thereby preventing damage to the image.

Images printed upon recording media such as paper, film, photo base, and the like, are often compromised by smudges, smears, and fading due to the chemical interaction between the colorants used to print the image and atmospheric oxygen (hereinafter “air fade”). As used herein, the term “colorants” refers to dyes, inks, pigments, and toners used in common printing processes including, but not limited to, laser, inkjet, and digital printing processes. To protect these images, manufacturers have devised protective coatings that are applied to a substrate of the recording media to prevent smudging, smearing, and air fade. One very simple example of such a protective coating is an adhesive plastic sheet that is laminated to the recording media over an image printed thereon. While functional, such protective coatings are typically not aesthetically pleasing and are generally very costly.

A more sophisticated example of such protective coatings includes the application of a protective layer of material directly over a previously existing image receiving layer of the recording media. The use of such protective coatings lends itself to high output printing processes, but it has a drawback of requiring additional processing equipment. Furthermore, the use of two, distinct layers can also lead to blistering of the recording media where the protective layer and the image-receiving layer are not perfectly compatible with one another.

Accordingly, there is a recognized need for a coating for media that functions both as an image-receiving layer and as a protective coating and which is adaptable for high speed printing operations. Such a coating may simplify the treatment process whereby recording media is prepared for printing by reducing the amount of equipment needed to coat the recording media. What is more, combining the image receiving and protective functions into a single coating will also reduce and even eliminate problems such as blistering that occur frequently where thermal fusing processes are used.

### SUMMARY

The objectives of the present invention are realized in a method for printing a substantially permanent, smudge-, water-, and air fade-resistant image on recording media that begins with the steps of formulating a fusible media coating and then applying that coating to at least one side of the recording media. Next, an image is printed on the recording media, over the coating, by applying a colorant to the recording media. Finally, the fusible media coating is fused so as to form a protective film over the recording media. The resulting protective film substantially encapsulates the colorant that was used to print the image onto the recording media, thereby rendering the image substantially permanent and substantially smudge, water, and air fade resistant.

The fusible media coating is essentially an admixture of a binder and a quantity of fusible particles. The fusible particles preferably have a diameter of between 0.3-18.0 μm. Note that the fusible media coating is capable of absorbing substantially all of the colorant that is applied to the coating when the coating is in its unfused state. The fusible media coating substantially permanently bonds the image printed thereon to the recording media.

### DETAILED DESCRIPTION

The present invention is a coating for recording media that includes fusible particles in a binder. The fusible particles not only act as a bulking agent for the purpose of smoothing the surface of the recording media to which the coating is applied, but also act to encapsulate and protect colorants such as inks, dyes, and pigments applied to the recording media during a printing process. The fused coating forms a substantially permanent bond with substrate to which it is applied. One embodiment of the present invention includes a mordant and/or a cross-linking agent along with the binder and fusible particle mixture.

While the present invention will be described herein as being used in conjunction with recording media destined for printing in an inkjet process, it is to be understood that recording media that is printed using other processes, including but not limited to digital printing such as laser printing and inkjet printing and offset printing, are also to be considered within the scope of the present invention.

Recording media typically comprises a substrate or base layer having a first side and a second side. As used herein, recording media may be taken to mean paper, films, or other substrates upon which images may be formed using a colorant that includes a pigment or dye. Note that in some instances these substrates may be absorptive such that the substrate will itself absorb the colorants used to print an image thereon. However, the coating may itself be considered an absorptive coating and therefore the substrates upon which an image is printed may be non-absorptive. Examples of non-absorptive substrates include, but are not limited to heat resistant plastic films and glass. As can be appreciated from the fact that the coating may be used successfully on non-absorptive substrates, it is to be understood that the coating is fully functional with respect to absorption, encapsulation, and protection colorants applied thereto. Note also that the coating is securely bonded to the substrate of the recording media in a substantially permanent manner. Accordingly, the coating may be used by itself to good effect on an otherwise uncoated substrate or may be used in conjunction with other pre-existing coatings that have been previously applied to the substrate.

Coatings in general are applied to recording media so as to impart to at least one of the sides the desired finish, brightness, and absorption characteristics. Typically, these coatings are applied to both sides of the recording media as either or both sides of the media may be printed upon. A coating according to the principles of the present invention includes, in addition to a binder, fusible particles. The admixture of the binder and fusible particles not only acts to fill defects in the surface of the recording media, but also absorbs at least a portion of the colorants when such are applied to the recording media before the fusible particles have been fused. Once they have been thermally fused however, the fusible particles form a substantially continuous film that substantially seals the surface of the recording media and encapsulates the colorants therein. Note that this fused coating also forms a substantially permanent bond with the substrate on which it is deposited. This fused, continuous film substantially prevents direct physical contact with the colorants and limits exposure of the colorants to the air. Accordingly, the image printed on the recording media is substantially permanent, is resistant to smudging, water damage, and fading from exposure to the atmosphere, and may possibly be more resistant to fading due to the incidence of light thereon.

In one embodiment of the present invention, the fusible particles of the coating are made of a quantity of particles of polymer latex suspended or dispersed in a compatible binder. Both solid and hollow fusible particles may be used and these particles are generally between 0.3 and 18 μm in diameter. Note that various types of polymer latexes may be used. For example, polymer latexes that may be used as part of the formulation of the coating may include latex acrylates and latex polyethylenes. Specific examples of suitable fusible particles that may be used in formulating the coating include, but are not limited to polymer latexes, polyethylene and Fischer-Tropsch wax dispersions and/or emulsions. Examples of these dispersions and/or emulsions are sold under the trade names Michem Guard 20, 25, 55, and 60, respectively; these additives being available from Michelman, Inc. of Cincinnati, Ohio. Other examples of suitable latex polymers include: Ropaque HP 1055 and Ropaque AF 1055(Rohm & Haas Company, Philadelphia, Pa.) and PC-205 (Mead Westvaco Corporation, Charleston, S.C.). The fusible particles are chosen not only to provide a protective film for the colorants applied to the recording media, but must also have a suitable absorptiveness and must be compatible with the binders and other components of the coating as well. As indicated above, the fusible particles may be solid or hollow.

The binder used in the coating must be one that is compatible with the fusible particles described hereinabove. Natural binders, such as starch and protein, and synthetic binders such as styrene/butadiene (S/B), styrene/acrylate (S/A), styrene/butadiene/acrylonitrile (SB/AN), polyvinyl acetate (PVAC), and polyvinyl alcohol (PVOH) may be used. One example of a suitable polyvinyl alcohol binder is sold by Specialities Europe GmbH of Frankfurt Germany under the trade name Mowiol 20-98. The Rohm and Haas Company of Philadelphia, Pa. sells another example of a suitable acrylic binder under the trade name Rhoplex GL 618.

In some instances it may be desirable to add a cross-linking agent to the binder. The BASF Corporation of Mount Olive, N.J. sells one example of a suitable cross-linking agent under the trade name Curesan 200. It is to be understood that the cross-linking agent is to be selected based on its compatibility with the fusible particles used in the coating.

To further improve the performance of the coating, it is desirable to include a mordant in the formulation of the coating. The mordant acts to create a chemical and/or physical bond between the colorants and the fusible particles of the coating. The identity of the mordants will typically vary with the chemistry of the colorants that are to be “set” in the coating. For example, where anionic dyes are used to print images on the recording media, cationic mordants such as a polyacrylate may be used. One suitable mordant is commercially available as Agefloc B-50 from CPS Chemical Co., Inc. of New Jersey, U.S.A. Another example of a suitable mordant is aluminum formate. Yet another example is an acrylic mordant, commercially available from PPG Industries, of Pennsylvania, USA, as WC-99 or WC-71. Furthermore, a mordant named Induquat ECR 35, commercially available from Indulor Chemie GmbH, Germany can also be used.

When colorants are applied to the surface of recording media having the coating thereon, the pigments and/or inks of those colorants are drawn into the coating and, where the substrate is itself absorptive, at times partially into the substrate of the recording media itself. The printed recording media may optionally be subjected to a drying process in which the solvents or carriers of the colorants are allowed to evaporate or cure before the printed recording media is submitted to a thermal fusing process whereby heat, and optionally pressure, are applied to the recording media so as to fuse the discrete fusible particles of the coating into a unitary protective layer on the substrate that effectively encapsulates substantially all of the colorants applied to the recording media during the printing process.

As the permeability of the coating is directly related to the size of the fusible particles, care must be taken in specifying the particle size such that substantially all of the colorants will be absorbed into the coating prior to the fusing process. Because colorants are formed of materials having molecules or particles of varying size, different types of colorants are absorbed into the coating at different rates. For example, liquid dyes, such as those used in inkjet printing comprise relatively small molecules and/or particles that are readily absorbed into and through the coating. The particles that give color to solid pigment colorants tend to be larger and therefore disperse through the coating at a somewhat slower rate.

Accordingly, the size of the fusible particles may be chosen to promote the absorption of substantially all of the colorants being applied to the recording media into the coating and away from the exterior surface of the recording media, be they liquid dyes or solid suspended pigments. Where colorants having solid pigments are used, one embodiment may include fusible particles having a diameter of about 2.4 μm or greater. Similarly, where liquid dyes are used, one embodiment may include fusible particles as small as 0.3 μm. Because there is a desire to use the coating of the present invention with all types of colorants, liquid and solid pigment, one embodiment of the present invention utilizes fusible particles that are between about 0.3 μm and 18.0 μm in diameter.

While the diffusion of solid pigment colorants into the coating is generally limited, the much smaller molecules of the liquid dyes tend to rapidly diffuse into the coating. Because such rapid diffusion of the liquid dyes might lead to the muddying or bleeding of the image being printed, one embodiment of the coating includes a suitable mordant as described above. The mordant acts to limit the diffusion of colorants to within the coating and maintains the quality of the image printed upon the recording media.

A coating formulated according to an embodiment of the present invention may be applied to the media in many different ways. As a first step, the respective components of the coating are mixed, preferably in a wet state. Note the specific order of mixing and the manner in which the components are compounded may vary, but once the coating has been properly mixed, it may be applied to the media using one of many premetered coating methods and machinery that may include, but are not limited to, the use of slot dies and curtain coating devices. Other methods and devices for coating media that may be useful may include rod coating and shear roll devices. After the coating has been applied to a pre-selected substrate, the newly applied coating is allowed to dry. This drying step may be effected by simply allowing the coated substrate to air dry, or more preferably, forced air dryers using air of ambient temperature or air that has been gently warmed may be used to speed the drying process. Note that the means whereby the newly coated substrate may be dried may vary from application to application, but it must be kept in mind that the temperatures used in this drying step must be below the glass transition temperature of the fusible particles of the coating itself to avoid premature fusion of the particles of the coating.

Once the coating has been applied to the recording media and properly dried, an image may be printed onto the coated recording media. Note that any suitable printing process or mechanism may be used, including but not limited to inkjet printers, laser printers, and the like. The colorants used to form the image on the coated media may be one of, or more likely a combination of, liquid inks or dyes, solid pigments applied dry or in a liquid carrier, or toners. Note that the process whereby an image is printed upon the coated media may be accomplished in a single pass or using multipass print modes. Furthermore, multiple shades or colors of colorants may be utilized in this printing process.

In some instances, the coated recording media, now having a newly printed image thereon, will be subjected to an intermediate drying step in which the solvents of the colorants are removed from the recording media. Removing the solvents left on the recording media by the colorants is desirable as encapsulation of the solvents with the colorants in the coating may degrade image quality or cause the formation of blisters during the subsequent fusion process. This drying step may involve a simple air-drying process or it may involve the use of heated or unheated forced air dryers, infrared heaters, or the like. Once the colorant solvents have been removed from the recording media, the recording media will then be subjected to a fusing process.

The fusible particles of the coating are fused into a single unitary film by the application of heat thereto. In one embodiment, the printed recording media may be subjected to high intensity infrared or visible light, the incidence thereof on the printed recording media being sufficient to fuse the discrete fusible particles of the coating into the aforementioned film. In addition to the application of heat to the printed media, it may be useful to apply pressure to the heated, printed recording media in order to ensure that the protective layer that results from the fusion of the fusible particles has the desired surface finish. For example, the printed media may be exposed to a heat source sufficient to render the fusible particles plastic, whereupon it will be passed between a stationary platen and a movable belt. The pressure applied to the heated coating of the newly printed recording media by the belt and platen acts to smooth the surface of the coating and to remove the heat therefrom so as to rapidly harden it. Another embodiment of the fusing process may involve the use of a pair of rollers in lieu of the platen and belt. Suitable rollers may be made of steel, silicone, or composite materials. In any case, at the end of the fusing process, the recording media will have a fused coating bonded to one or more of its sides in which a printed image is substantially encapsulated. The resulting image on the recording media is substantially permanent and is resistant to smudging, water, and air fade.

As described above, the methods used to fuse the fusible particles of the coating vary from application to application. However, in general, to obtain a suitable surface quality, both temperature and pressure are applied to the coating. In order to smooth the fusible particles into a uniform, substantially impervious coating, the fusible particles are raised to or near to their glass transition temperature (T_{g}) and then compressed or otherwise mechanically manipulated so that the individual particles flow together to form a continuous layer. It is desirable to specify a fusible particle for use in the coating that has a T_{g} within a predetermined suitable range. Where the T_{g} of the fusible particles is above the suitable range, the amount of heat required may damage the recording media. Depending on the nature of the component parts of the coated recording media, excessive heat may induce the formation of blisters between the fusible coating and the substrate or may even scorch the recording media or the colorants applied thereto. Accordingly, in one embodiment the fusible particles used in the coating have a T_{g} of no more than 125° C. What is more, where the T_{g} of the fusible particles is below the predetermined suitable range, the resulting recording media may be easily damaged by inadvertently heating the recording media to above the T_{g} of the fusible particles. Such inadvertent heating regularly occurs during the shipment and storage of recording media. Accordingly, in one embodiment of the present invention the fusible particles used in the fusible coating have a T_{g} of at least 65° C. Another embodiment of the present invention utilizes fusible particles having a T_{g} of between 70° C.-90° C.

In some instances, an increase in the pressure applied to the coating during the fusing process may allow for an increase in the specified T_{g} of the fusible particles of the fusible coating. Where a mechanical force of greater magnitude is applied to the fusible particles, the mechanical manipulation of the particles obviates the need for an increased plasticity in the particles that accompanies a relatively lower T_{g}. In one embodiment of the present invention, hollow fusible particles are used in the coating. These hollow fusible particles are more easily deformed than solid particles with the same T_{g}. Therefore, where hollow fusible particles are used in the coating, the pressure applied to the fusible coating during fusing may be lowered while at the same time, the T_{g} of the hollow fusible particles themselves may be higher than the T_{g} of similar solid fusible particles. The use of hollow fusible particles in the coating can simplify the fusing process as bother lower pressures and temperatures may be used to achieve an acceptable fused coating over the recording media.

In one particular embodiment of the present invention, a fusible coating is applied to a photo base recording media. The photo base recording media comprises a substrate formed of a paper core having an extruded polyethylene layer bonded to at least one, and preferably both, sides thereof. The fusible coating is applied over the polyethylene layer(s) of the photo base recording media and dried as described above. An image may then be printed thereon using any one of the described process/mechanisms. After the image has been printed, the printed recording media is subjected to a fusing process whereby the fusible coating is fused to form a substantially impervious protective layer over the image printed on the recording media. The fused coating is also substantially permanently bonded to the polyethylene-coated substrate of the recording media.

In one embodiment of the present invention, the coating is formulated (by parts) as follows:

| | |
|---|---|
| Binder | about 7-20 parts |
| Fusible Particles | about 100 parts |

In another embodiment of the present invention, the coating is formulated (by parts) as follows:

| | |
|---|---|
| Binder | about 7-20 parts |
| Fusible Particles | about 100 parts |
| Mordant | about 3-15 parts |

Another embodiment of the present invention includes a formulation (by parts) as follows:

| | |
|---|---|
| Binder | about 7-20 parts |
| Fusible Particles | about 100 parts |
| Mordant | about 3-15 parts |
| Crosslinking Agent | about 1 part |

Yet another embodiment of the coating of the present invention is formulated (by weight percent) as follows:

| | |
|---|---|
| Binder | about 2-40% |
| Fusible Particles | about 60-98% |
| Mordant | up to about 10% |
| Crosslinking Agent | up to about 2% |

### CONCLUSION

Although specific embodiments have been illustrated and described herein it is manifestly intended that this invention be limited only by the following claims and equivalents thereof.

What is claimed is:

1. A method of printing a smudge, water, and air fade resistant image on recording media, the method comprising the steps of:
formulating a fusible media coating;
applying the media coating to at least one side of the recording media;
printing an image on the at least one coated side of the recording media by applying a colorant thereto; and,
fusing the fusible media coating so as to form a protective film over the recording media that is substantially permanently bonded to the recording media, the protective film substantially encapsulating the colorant used to print the image onto the recording media, the encapsulation of the colorant by the protective film rendering the image substantially permanent and substantially smudge, water, and air fade resistant.

2. The method of printing a smudge, water, and air fade resistant image on recording media of claim 1 wherein the fusible media coating comprises:
a binder and a quantity of fusible particles admixed with the binder, the fusible particles having a diameter of between 0.3-18.0 μm, the admixture of the fusible particles and binder being capable of absorbing substantially all of a colorant that is applied to the admixture, the admixture of fusible particles and binder being applied to at least one side of the media when the fusible particles are in a first, unfused state.

3. The method of printing a smudge, water, and air fade resistant image on recording media of claim 2 wherein the fusible particles are selected from a group consisting of hollow particles and solid particles.

4. The method of printing a smudge, water, and air fade resistant image on recording media of claim 2 wherein the fusible particles have a glass transition temperature (Tg) including and between 65° C. and 125° C.

5. The method of printing a smudge, water, and air fade resistant image on recording media of claim 2 wherein the fusible particles have a glass transition temperature (Tg) including and between 70° C. and 90° C.

6. The method of printing a smudge, water, and air fade resistant image on recording media of claim 1 further comprising the step of drying the recording media after the image is printed thereon to remove solvents from the colorant from the recording media prior to fusing the fusible particles.

7. The method of printing a smudge, water, and air fade resistant image on recording media of claim 1 wherein the recording media is chosen from a group consisting of an inkjet paper, a photo base, a coated paper, and an uncoated paper.

8. The method of printing a smudge, water, and air fade resistant image on recording media of claim 2 wherein the media coating further comprises a mordant.

9. The method of printing a smudge, water, and air fade resistant image on recording media of claim 8 wherein the mordant is selected from a group consisting of aluminum formate, polyacrylate, and polydiallyl dimethyl ammonium chloride.

10. A fusible coating for media comprising:
a binder and a quantity of fusible particles admixed with the binder, the fusible particles having a diameter of between 0.3-18.0 μm, the admixture of the fusible particles and binder being capable of absorbing substantially all of a colorant that is applied to the admixture, the admixture of fusible particles and binder being applied to at least one side of the media when the fusible particles are in a first, unfused state; and,
wherein the application of heat to the fusible coating above a predetermined temperature threshold will thermally fuse the fusible particles so as to transform the admixture of binder and fusible particles into a continuous film, the continuous film substantially encapsulating therein and securing to the media in a substantially permanent manner substantially all of a colorant applied to the fusible coating.

11. The fusible coating for media of claim 10 wherein the fusible coating is applied directly to a substrate of the media.

12. The fusible coating for media of claim 11 wherein the substrate of the media is chosen from a group consisting of raw paper, coated paper, photo base, plastic film, and glass.

13. The fusible coating for media of claim 10 wherein the fusible particles are selected from a group consisting of hollow fusible particles and solid fusible particles.

14. The fusible coating for media of claim 10 wherein the fusible particles are selected from a group consisting of polymer latexes, polyethylene and Fischer-Tropsch wax dispersions and/or emulsions.

15. The fusible coating for media of claim 10 wherein the binder is selected from a group consisting of starch, protein, styrene/butadiene, styrene/acrylate, styrene/butadiene/acrylonitrile, polyvinyl acetate, and polyvinyl alcohol.

16. The fusible coating for media of claim 10 further comprising a mordant.

17. The fusible coating for media of claim 16 wherein the mordant is selected from a group consisting of aluminum formate, polyacrylate, and polydiallyldimethyl ammonium chloride.

18. The fusible coating for media of claim 10 further comprising a cross-linking agent.

19. The fusible coating for media of claim 18 wherein the cross-linking agent is selected from a group consisting of Curesan 200.

20. The fusible coating for media of claim 10 wherein the fusible particles are about 2.4 μm in diameter.

21. The fusible coating for media of claim 10 wherein the fusible particles have a glass transition temperature (Tg) of 65° C.-125° C.

22. The fusible coating for media of claim 10 wherein the fusible particles have a glass transition temperature (Tg) of 70° C.-95° C.

23. A fusible coating for media comprising:
about 7-20 parts binder and about 100 parts fusible particles.

24. The fusible coating for media of claim 23 further comprising:
about 3-15 parts mordant.

25. The fusible coating for media of claim 23 further comprising:
about 1 part crosslinking agent.

26. The fusible coating for media of claim 23 wherein the fusible particles are selected from a group consisting of hollow particles and solid particles.

27. The fusible coating for media of claim 23 wherein the fusible particles have a glass transition temperature (Tg) including and between 65° C. and 125° C.

28. The fusible coating for media of claim 23 wherein the fusible particles have a glass transition temperature (Tg) including and between 70° C. and 90° C.

29. A fusible coating for media comprising:
about 2-40% binder and
about 60-98% fusible particles.

30. The fusible coating for media of claim 29 further comprising:
up to about 10% mordant.

31. The fusible coating for media of claim 29 further comprising:
up to about 2% crosslinking agent.

32. The fusible coating for media of claim 29 wherein the fusible particles are hollow.

33. The fusible coating for media of claim 29 wherein the fusible particles are solid.

34. The fusible coating for media of claim 29 wherein the fusible particles have a glass transition temperature (Tg) including and between 65° C. and 125° C.

35. The fusible coating for media of claim 29 wherein the fusible particles have a glass transition temperature (Tg) including and between 70° C. and 90° C.
